(19) United States
(12) Patent Application Publication
(10) Pub. No.: US 2025/0132600 A1
(43) Pub. Date: Apr. 24, 2025

(54) METHODS FOR PREDICTING ENERGY LEVEL FOR AN ENERGY HARVESTING WIRELESS DEVICE, A RELATED NETWORK NODE AND A RELATED WIRELESS DEVICE

(71) Applicant: Sony Group Corporation, Tokyo (JP)

(72) Inventors: Nafiseh Seyed MAZLOUM, Lund (SE); Anders BERGGREN, Lund (SE); Torgny PALENIUS, Barsebäck (SE); Basuki PRIYANTO, Lund (SE)

(21) Appl. No.: 18/681,440

(22) PCT Filed: Aug. 30, 2022
(86) PCT No.: PCT/EP2022/074006

§ 371 Date: Feb. 5, 2024

(30) Foreign Application Priority Data
Aug. 30, 2021 (SE) 2151085-4

(51) Int. Cl. H02J 50/00; G06Q 10/0631; H02J 9/00; H02J 50/20; H02J 50/80

(52) U.S. Cl. CPC H02J 50/001; G06Q 10/0631; H02J 9/005; H02J 50/20; H02J 50/80

(57) ABSTRACT

A method is disclosed, performed in a network node, for enabling a prediction of an energy level of an energy harvesting wireless device, WD. The method comprises receiving, from the WD, information assisting the network node to obtain an algorithm for predicting the energy level of the WD. The method comprises receiving, from the WD, parameters for use by the algorithm in predicting the energy level of the WD. the parameters comprise energy harvesting properties and parameters associated with current use of the WD, whereby prediction of the energy level of the WD is enabled.

The present disclosure pertains to the field of wireless communications. The present disclosure relates to methods enabling a prediction of an energy level of an energy harvesting wireless device (WD), a related network node and a related wireless device.

### BACKGROUND

Future services will likely require cellular connectivity everywhere, anytime and in everything. This means that the number of devices that have to be wirelessly connected, which are also referred to as internet of Things (IoT) devices, is going to explode. A vast majority of these devices are battery powered and their batteries need to be recharged or replaced.

Changing/recharging batteries manually is not feasible, as e.g., a trillion-IoT device world with 10-year battery life-time means that in total ˜274 billion batteries need changing every day and a 10-year battery life-time cannot even be fulfilled in many applications. In an IoT context, 10-years battery life means a 10-years battery operation without charging which cannot even be fulfilled in many applications.

Recycling batteries is another factor that needs to be considered, for instance in 2018 191 000 tones of portable batteries were sold in the EU but only near half the amount, i.e., 88 000 tones of used portable batteries were collected as waste to be recycled.

This means that new approaches need to be used to sustain the world's need for batteries, since these materials are very limited. Energy harvesting is a potential candidate that can help avoid an exploding request for batteries in the world and keep the limited natural materials un-harvested.

For certain application of IoT devices, for example devices that are placed in difficult to reach and/or remote locations, it may be difficult to charge the device frequently and/or manually. This kind of IoT-device may typically be reporting sensor outputs infrequently. It may be equipped with a limited battery capacity. Hence, it may be charged in full capacity using energy harvesting.

Harvesting resources, however, might not be available all the time especially if they are harvested from ambient or natural resources. The harvesting capabilities also depend on whether a device is stationary in an indoor or outdoor environment or is a mobile device as the intensity of energy harvesting can vary based on its location and its activity. Consequently, the device might not be able to communicate with the network or other devices during a certain period when the instantaneous harvesting energy is not available, not enough and/or the stored energy level drops below a certain level. This condition may typically lead to excessive unnecessary signaling which may increase the overhead and usage of unnecessary energy resources when the device has harvested enough energy and restarts communication.

### SUMMARY

The time when the device can perform energy harvesting may not be foreseeable to the network if no information is exchanged between the WD and the network in advance, since the energy consumption and the harvesting possibilities are dependent on the use of the WD. Additionally, the amount of energy that can be stored may be limited and the device can run out of the back-up stored energy. Consequently, the device might not be able to communicate with the network or other devices during a certain time period when the instantaneous harvesting energy is not available, not sufficient and/or the stored energy level drops below a certain level. Furthermore, communication between the WD and the network, such as the WD signaling that it has a low energy level every time the energy level drops below a certain level, is energy consuming which further drains the energy level of the WD. The WD signaling every time it has a low energy level is thus a waste of energy that could otherwise be used for data communication between the WD and the network.

Accordingly, there is a need for network nodes, wireless devices and methods enabling a prediction of an energy level of an energy harvesting wireless device (WD), which may mitigate, alleviate or address the shortcomings existing and may provide a solution that reduces the unavailability of the WD due to insufficient energy levels.

A method is disclosed, performed in a network node, for enabling a prediction of an energy level of an energy harvesting wireless device, WD. The method comprises receiving, from the WD, information assisting the network node to obtain an algorithm for predicting the energy level of the WD. The method comprises receiving, from the WD, parameters for use by the algorithm in predicting the energy level of the WD. The parameters comprise energy harvesting properties and parameters associated with current use of the WD, whereby prediction of the energy level of the WD in the network node is enabled.

Further, a network node is provided, the device comprising memory circuitry, processor circuitry, and a wireless interface, wherein the network node is configured to perform any of the methods disclosed herein for the network node.

It is an advantage of the present disclosure that the network node may predict the energy level of the WD and may use the predicted energy level of the WD to schedule upcoming message exchange, such as communication, between the WD and the network node. It can thereby be ensured that the energy harvesting wireless devices and the network can adapt the communication based on the WD energy level, recharging capability and harvesting possibilities and thereby communicate without device unavailability interruption period, since the communication is performed intelligently and based on the availability of energy resources, assistance information, such as positioning, environmental data, sensor inputs, or mobility pattern, and history of communication between the network and the wireless device. By predicting the energy level of the WD, the network node may provide assistance to the WD, such as energy harvesting assistance, when the network node predicts the energy level to be insufficient for communication. Since the network node predicts the energy level of the WD, the assistance may be provided without the WD requesting assistance from the network node. Thereby the communication between the WD and the network node can be reduced, which reduces the energy consumption of the WD and thereby reduces the risk of the energy level of the WD being insufficient for communication.

A method is disclosed, performed in an energy harvesting wireless device, WD, enabling a prediction of an energy level of the energy harvesting WD by a network node. The method comprises transmitting, to the network node, information assisting the network node to obtain an algorithm for predicting the energy level of the WD. The method comprises transmitting, to the network node, parameters for use by the algorithm in predicting the energy level of the WD. The parameters comprise harvesting properties and parameters associated with a current use of the WD, thereby enabling the network node to predict the energy level of the WD.

Further, a wireless device is provided, the device comprising memory circuitry, processor circuitry, and a wireless interface, wherein the wireless device is configured to perform any of the methods disclosed herein for the wireless device.

It is an advantage of the present disclosure that the wireless device can enable the network node to predict the energy level of the WD and to schedule upcoming message exchange, such as communication, between the WD and the network node based on the predicted energy level of the WD. It can thereby be ensured that the energy harvesting wireless devices and the network can always adapt the communication based on the energy level, recharging capability and/or harvesting possibilities/capabilities of the WD. Since the communication can be performed intelligently and based on the availability of energy resources, assistance information, such as positioning, environmental data, sensor inputs, or mobility pattern, and history of communication between the network and the wireless device, the WD and the network node can communicate without a device unavailability interruption period which may occur when the WD is unavailable due to insufficient power. By enabling the network node to predict the energy level of the WD, the network node may provide assistance to the WD, such as energy harvesting assistance, without the WD having to request assistance from the network node. Thereby the communication between the WD and the network node can be reduced, which reduces the energy consumption of the WD and thereby reduces the risk of the energy level of the WD being insufficient for communication.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node and an example wireless device according to this disclosure,

FIG. 2 is a block diagram illustrating exemplary energy limited sub-states of RRC modes for the WD according to this disclosure,

FIG. 3 is a flow-chart illustrating an example method, performed in a network node for prediction of an energy level of the wireless device according to this disclosure,

FIG. 4 is a flow-chart illustrating an example method, performed in a wireless device for enabling prediction of an energy level of the wireless device according to this disclosure,

FIG. 5 is a block diagram illustrating an example network node according to this disclosure,

FIG. 6 is a block diagram illustrating an example wireless device according to this disclosure, and

FIG. 7 is a signaling diagram illustrating an exemplary message exchange for enabling prediction of an energy level according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

A connected mode may be referred to an operation mode wherein a data transmission can be communicated e.g., between the wireless device and a network node or between the wireless device and another wireless device. A connected mode may be referred to an operation state wherein a radio transmitter and/or a radio receiver is activated for such communication. A connected mode may be referred to an operation state wherein the wireless device is synchronized time-wise and/or frequency-wise e.g., by a determined timing advance parameter for the communication. Furthermore, it may be referred to as an operation state wherein transfer of unicast data to/from the wireless device can be performed. In certain communication systems, a connected mode may be referred to a radio resource control (RRC) state. In various examples, an active state may be a RRC connected state and/or an RRC active state. However, a connected mode may be an active period within another RRC state.

The dormant mode is a mode where the UE has no active connection with the network node. A dormant mode may be seen as an inactive mode of the wireless device. A dormant mode may be seen as a mode where the wireless device is unsynchronized with a timing of a network. In one or many examples the wireless device may in a dormant mode not have a valid timing advance information with respect to the network. A dormant mode may be seen as a mode where the wireless device may not be able to receive dedicated signaling. A dormant mode may be seen as a mode where closed loop power control is inactivated or suspended. Dormant mode may comprise RRC idle mode, RRC suspend and/or RRC inactive mode. For example, the wireless device may be in dormant mode when the connection with the network node has been released and/or suspended.

The figures are schematic and simplified for clarity, and they merely show details which aid understanding the disclosure, while other details have been left out. Throughout, the same reference numerals are used for identical or corresponding parts.

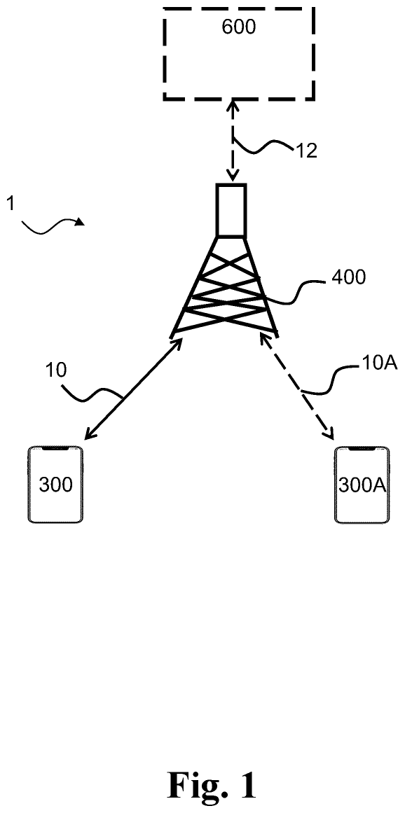

FIG. 1 is a diagram illustrating an example wireless communication system 1 comprising an example core network (CN) node 600, a radio network node 400 and an example wireless device (WD) 300 according to this disclosure.

As discussed in detail herein, the present disclosure relates to a wireless communication system 1 comprising a cellular system, for example, a 3GPP wireless communication system. The wireless communication system 1 comprises a WD 300 and/or a network node 400. The WD 300 may be an energy harvesting wireless device configured use energy harvesting sources to harvest the energy required by the WD 300 for communicating with the network node 400 or a second WD 300A.

A network node disclosed herein refers to a radio access network node operating in the radio access network, such as a base station, an evolved Node B, eNB, gNB in NR, or a CN node. In one or more examples, the RAN node is a functional unit which may be distributed in several physical units.

A core network, CN, node disclosed herein refers to a network node operating in the core network, such as in the Evolved Packet Core Network, EPC, and/or a 5G Core Network, 5GC. Examples of CN nodes in EPC include a Mobility Management Entity, MME.

In one or more examples, the CN node is a functional unit which may be distributed in several physical units.

The CN node 600 may be configured to communicate with the RAN node 400 via a link, such as a wired link, 12.

The wireless communication system 1 described herein may comprise one or more wireless devices 300, 300A, and/or one or more network nodes 400, such as one or more of: a base station, an eNB, a gNB and/or an access point, and one or more CN nodes 600. A wireless device may refer to a mobile device, a user equipment (UE) and/or other devices having wireless capability, such as e.g., sensors wirelessly transmitting the measured data.

The wireless device 300, 300A may be configured to communicate with the network node 400 via a wireless link (or radio access link) 10, 10A.

The present disclosure provides a mechanism where the network node is enabled to predict the energy level of the energy harvesting WD, based on e.g., the energy harvesting and/or energy consumption behavior of the WD. Techniques for predicting an energy level of the WD by the WD itself are known, such as from US 2019/094931 A1. The current disclosure is however relating to methods where the network node predicts the energy level of the WD. The network node may communicate, such as schedule communication, with the WD based on the predicted available energy resources of the WD. Based on the predicted energy level the network node may also assist the WD on performing energy harvesting. The energy level may be seen as the harvested energy minus the consumed energy of the wireless device. The consumed energy may herein be the energy required for performing communications with the network node. A predicted energy level may thus be the predicted harvested energy minus the predicted consumed energy.

The network node may e.g., use external information (such as e.g., sensor data, location data, such as the position or mobility pattern of the WD) received from a second device, such as a second network node or a second WD and/or information reported by the WD to learn about the WD's harvesting possibilities (such as whether the device is located indoor or outdoor and which harvesting source the WD is using, such as solar energy, indoor light, vibration, thermal, or Radio Frequency (RF) using single antenna, Multiple Input Multiple Output (MIMO), Large Intelligent Surface (LIS) or Reconfigurable Intelligent Surfaces (RIS) technology), whether it is day or night, whether the WD is moving or is stationary (vibration), etc.

According to the present disclosure, the network, such as the network node, can predict when the WD can harvest energy. For example, a solar panel can only efficiently harvest energy when the sun is shining, directly or in-directly on the panel and is not too much obstructed by clouds or other obstacles. Harvesting from mechanical energy for example only works when for instance random vibration and human activity such as running, cycling, and walking is generating mechanical energy. By the WD signaling information relating to the energy harvesting of the WD, such as its parameters to be used by the algorithm in predicting the energy level of the WD, the network node is enabled to accurately estimate predict, such as estimate, the energy level of the WD. Accurately predicting the energy level of the WD allows the network node to schedule communication with the WD to ensure that data isn't lost due to the WD being unavailable due to the WD being out of power.

As an example, it can be assumed that the WD is a sensor in a bicycle and that the WD can harvest from a mechanical energy via vibration. The WD may also be capable of receiving power from the network. The location, such as the position, of the bicycle may be used as an input to the network for predicting, such as estimating, the energy level of the WD, such as of the sensor. Whenever the bicycle is used, a signal may be transmitted from the WD to the network node for updating the location of the WD. From this information the network may know that the WD has been exposed to vibration. If the network does not receive any location updates from the WD for a certain time period, wherein the time period may be a time interval necessary for the WD to harvest energy from vibration, then the network may predict that the energy level harvested from vibration is not sufficient. The network may then transmit power to the WD, such as via a wireless power transfer, to assist the WD with harvesting energy from RF.

In one or more examples, if the network learns that none of the ambient energy sources are going to be available within a certain time, and the WD energy level is predicted to not be sufficient for an upcoming communication, the network may assist the WD to harvest energy from RF by performing wireless energy transfer. The network node may transmit an excitation signal to an energy generating device to generate vibrations or create temperature differences so that the energy can be harvested by the WD.

In one or more examples, the WD energy harvesting behavior information known by the NW can be validated by the report from the WD. Here, the WD may provide feedback to the base-station so that the base-station can update its machine learning model. Hence the machine learning model is updated based on the WDs recent conditions/situations.

In one or more examples, in case the energy harvesting behavior of the WD cannot be predicted and/or controlled and/or the network cannot find a suitable algorithm, such as cannot create or train a suitable AI or machine learning model, due to too many or due to frequent unexpected or unknown events, the network may bar such a wireless device within a duration of time (such as e.g., until a suitable algorithm can be found, and/or a suitable AI or machine learning model can be created).

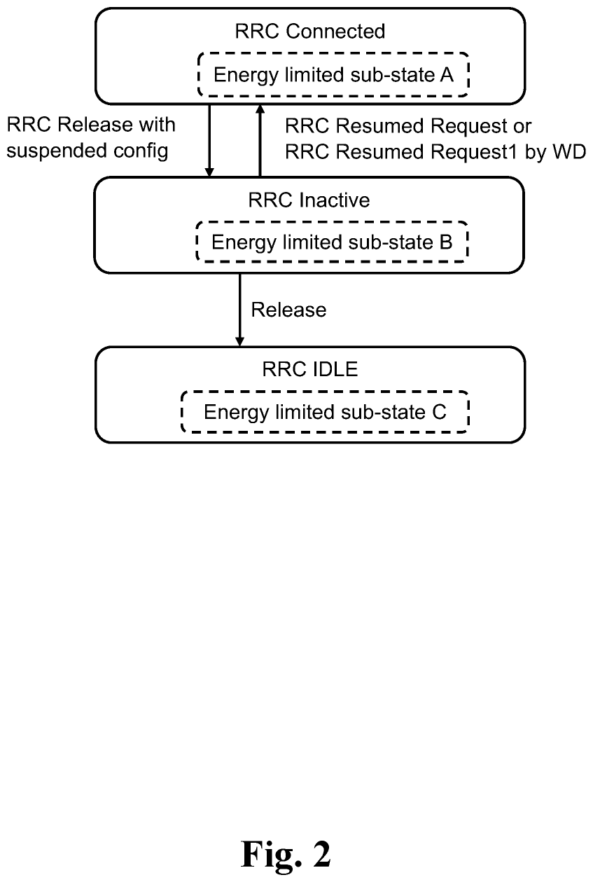

In one or more example methods, the WD may enter a sub-state of its current Radio Resource Control (RRC) mode, such as a sub-state of RRC IDLE-mode, a sub-state of RRC INACTIVE mode and/or a sub-state of RRC Connected mode, as shown in FIG. 2.

The sub-state may be a power limited state, in which the WD only harvests energy and recharges an energy storage device while the UE context for the WD is preserved with the network node. In other words, in the power limited state the WD may be unavailable for communication and therefore does not use any energy for communication. If the network knows, such as predicts, that the WD is harvesting energy and does not operate, such as communicate, when harvesting, the network may manage the signaling to/from the WD assuming the WD has entered the power limited sub-state. When the WD is in the power limited sub-state the network node and/or other WDs may not send anything to the WD, and the network assumes that the WD will not be able to read any broadcast. The network node may however keep the WD registered, such as preserves the UE context of the WD, until the energy source is active again, such as until the energy level is sufficient for communication. In one or more examples, the network may only transmit RF energy while the WD is in the power limited sub-state to assist the WD on harvesting energy. In one or more example, the network may also transmit an excitation signal to an energy generating device to generate vibration or create temperature difference so that the energy can be harvested by the WD. This may for example be done upon the network node learning and/or predicting, based on the algorithm, that the device does not have the possibility to perform energy harvesting from other resources. This prevents the network node from assuming that the WD has left the network during times when the WD is not available for communication and therefore unregister the WD from the network, such as from the core network. By preserving the UE-context of the WD with the network, such as with the core network, the WD may start to communicate directly once the energy level is sufficient. Thereby, no signaling is required to re-establish the UE-context, which would be the case if the WD had been unregistered, which in turn reduces the energy consumption of the WD.

In one or more example methods, the network node may know and/or may learn the traffic behavior of the WD. For example, the network node may know the buffer status of the device. In one or more example methods, the network node may, based on the known traffic behavior, instruct the device to harvest energy (instead of performing communication or staying in connected mode), especially during the optimal time to perform energy harvesting. The optimal time to perform energy harvesting may be dependent on the energy harvesting source used.

In one or more example methods, the WD provides an indication to the network node that the WD can be assisted and/or supported by the network node to perform the energy harvesting. This indication may be comprised in a UE capability reporting from the WD.

In one or more example methods, this can be dynamically changed using a control signaling, such as an RRC message. For example, the WD may receive a configuration (indicating that the WD can be assisted and/or supported by the network node) by an application layer of the network. Then, the WD may convey that information to the network node using an RRC configuration message.

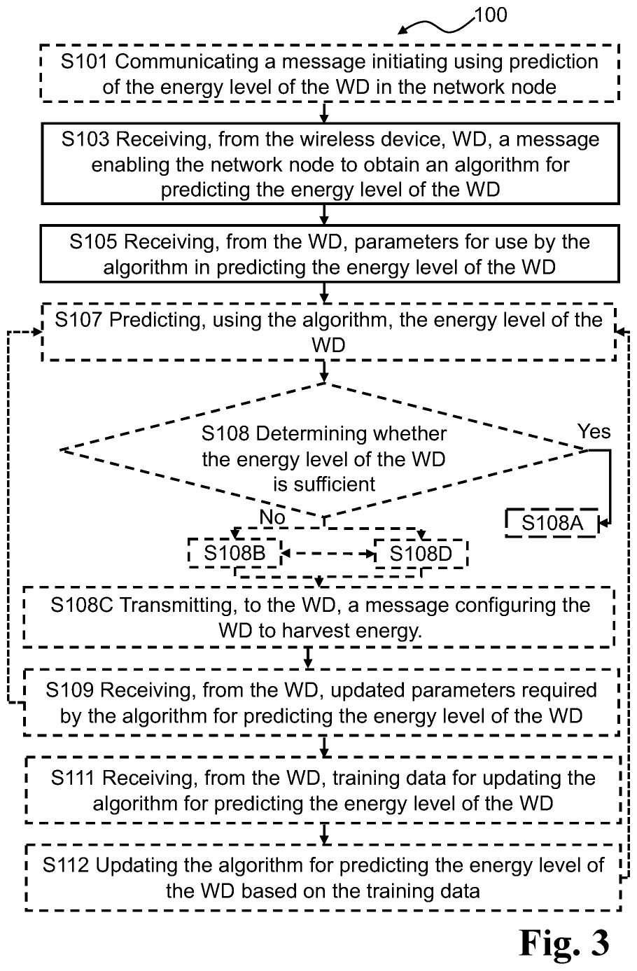

FIG. 3 shows a flow diagram of an example method 100, performed in a network node according to the disclosure, for enabling a prediction of an energy level of an energy harvesting wireless device, WD. The energy level may herein be seen as the harvested energy minus the consumed energy of the wireless device. The consumed energy may herein be the energy required for performing communications with the network node.

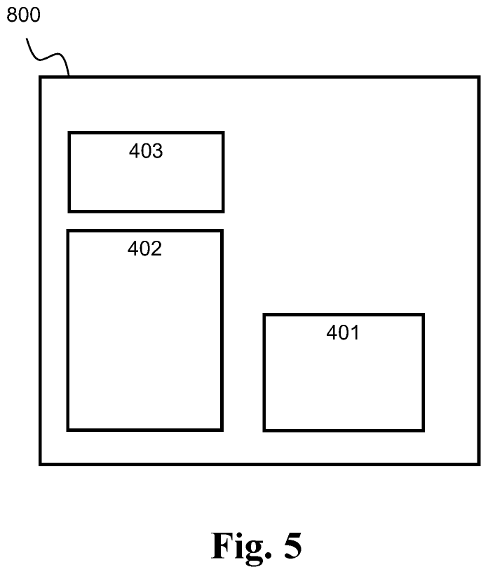

The method 100 may be performed by a network node, such as radio network node 400 of FIG. 1, and FIG. 5 and or CN node 600 of FIG. 1.

In one or more example methods, the method 100 comprises communicating S101 a message, such as at least one message, initiating using prediction of the energy level of the WD in the network node. The message initiating prediction of the energy level may, in one or more examples, comprise an indication that the WD may be assisted by the network node. In one or more examples, the message initiating prediction of the energy level may comprise an indication of the algorithm to be used, such as an indication of the AI model and/or machine learning model to be used. The algorithm, such as the AI and/or machine learning model, may for example be selected based on capabilities of the WD. Alternatively, this information could be pre-defined and/or based on UE subscription for the WD. The message may be a control message, such as a message transmitted via control signaling.

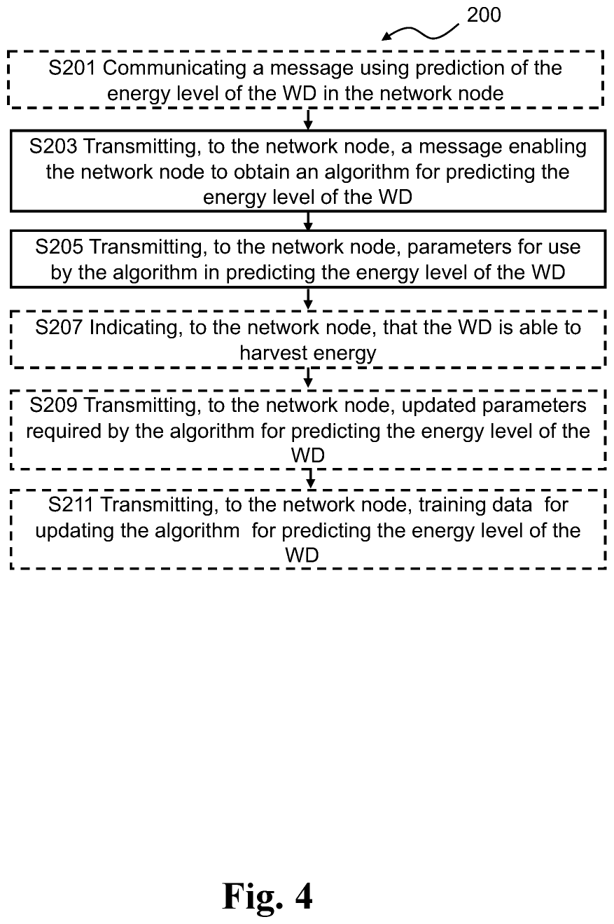

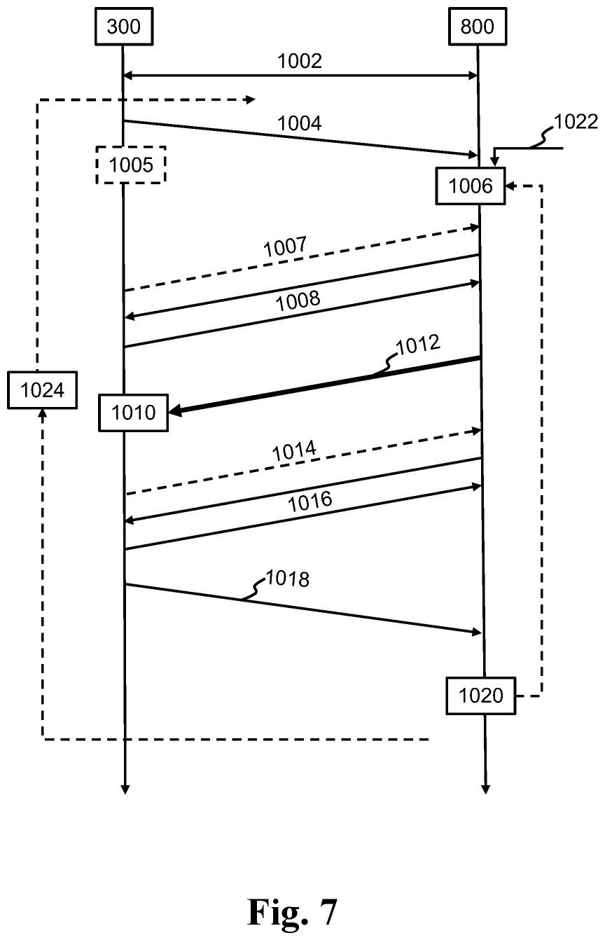

In one or more examples herein, communicating S101 the message initiating using prediction of the energy level may initialize the algorithm, such as the AI model. In one or more example methods, the algorithm may be initialized once in a lifetime of the device or when powering up the device, such as during initial setup of the WD. The algorithm may subsequently be updated repeatedly, such as using parameters associated with current use of the WD. Communicating S101 the message initiating using prediction may serve as an agreement between the WD and the network node to use prediction of the energy level of the WD at the network node before the WD starts transmitting the parameters for use by the algorithm in predicting the energy level of the WD. Communicating S101 corresponds to S201 of FIG. 4 and is similar to 1002 of FIG. 7.

The method 100 comprises receiving S103, from the WD, information assisting the network node to obtain, such as receive and/or retrieve, an algorithm for predicting the energy level of the WD. The information assisting the network node to obtain, such as receive and/or retrieve, the algorithm for predicting the energy level of the WD may be received via control signaling and/or a control message comprising the information. In one or more example methods, the information assisting the network node to obtain the algorithm may comprise the algorithm. In other words, the network node may receive the algorithm from the wireless device. In one or more example methods, the information assisting the network node to obtain the algorithm may be indicative of one or more of the type of the wireless device, an operational scenario of the wireless device, an indication of an algorithm to be used for predicting the energy level of the WD, and a location from where the algorithm can be retrieved. In one or more example methods, the algorithm may be a model, such as a trained model, such as an Artificial Intelligence (AI) model and/or machine learning model. In one or more examples, the AI model may be a pre-agreed or predetermined model. The network node may e.g., use artificial intelligence and/or machine learning computation to learn the energy harvesting behavior of the wireless device. Receiving S103 information assisting the network node to obtain an algorithm corresponds to S203 of FIG. 4 and is similar to 1002 of FIG. 7.

The method 100 comprises receiving S105, from the WD, parameters for use by the algorithm in predicting the energy level of the WD, such as to be used by the algorithm to predict the energy level of the WD. In one or more example methods, the parameters comprise energy harvesting properties and parameters associated with current use of the WD, whereby prediction of the energy level of the WD is enabled. Current use of the WD refers to properties that are not tied to the WD as such but to a context where the WD is currently operated. The parameters for use by the algorithm in predicting the energy level of the WD may be received via control signaling and/or a control message comprising the information. The current use may affect configuration, position etc. and consequently an ability to harvest energy, as well as energy consumption. Receiving S105 parameters for use by the algorithm in predicting the energy level of the WD corresponds to S205 of FIG. 4 and is similar to 1004 of FIG. 7.

Energy harvesting properties defines properties of the WD to harvest energy in general, for example available hardware. In one or more example methods, the energy harvesting properties may be indicative of one or more energy harvesting techniques, such as energy harvesting sources, which the WD has currently selected for energy harvesting. In one or more example methods, the energy harvesting techniques may comprise one or more of ambient energy (such as light energy, wind energy and/or vibration energy), or dedicated energy (such as wireless power transfer). Ambient energy harvesting relies on energy resources that are readily available in the environment and that can be sensed by energy harvesting devices where dedicated energy harvesting are characterized by on-purpose energy transmissions from dedicated energy sources to energy devices.

By the WD signaling the indication of the algorithm to be used and/or the parameters for use by the algorithm in predicting the energy level of the WD to the network node, the network node can be enabled to map the different energy harvesting sources to one or more respective suitable prediction algorithms. A prediction algorithm may thus not be limited to one harvesting source and the NW can find a suitable prediction algorithm for one or more energy harvesting properties of the WD, such as the given one or more harvesting techniques which the WD has currently selected or is capable of selecting for energy harvesting. For example, the WD may signal a change in its available one or more energy harvesting techniques, in order to enable the network node to select the most suitable algorithm for predicting the energy level of the WD. In one or more example methods, the WD may provide other and/or additional parameters as an input to the network node, such as positioning, weather information, which can enable the network node to more accurately predict the energy level of the WD and thus more effectively schedule upcoming message exchange.

Wireless power transfer may e.g. be performed by means of electromagnetic energy, such as via RF In one or more example methods, the WD may use one or more techniques, such as sources, for energy harvesting, such as light energy (for example via solar or indoor light), mechanical energy (for example via vibration, wind, water), thermal energy (for example via heaters, friction, solar, water, wind), and/or electromagnetic energy (for example via inductors, coils, radio frequency). These energies can be harvested from the environment or from human activity, may be converted to electrical power and used for wireless device operation. The harvested energy can also be stored in the WD, such as e.g., stored to re-chargeable Li-ion batteries, thin-film batteries, super-capacitors, or conventional capacitors. In one or more examples, the WD may be configured with hardware enabling the WD to use a plurality of different energy sources for harvesting energy. The WD may however select one or more of the plurality of the different energy sources to be used for energy harvesting during operation of the WD.

In one or more examples, energy harvesting properties can be represented as the type of energy source. This can be represented in some parameter values, for example, “00” represents light/solar, “01” represents vibration, and so on. In another example, energy harvesting properties can be represented as the maximum amount of energy provision. Maximum can be interpreted as in the best condition. This can be represented in some parameter values, for example: “00” represents the lowest value, such as 1-50 microWatt/cm², “01” represents 51-100 microWatt/cm², and so on.

The parameters associated with current use of the WD may in one or more example methods be assistance information assisting the network node in predicting the energy level of the WD using the algorithm. The parameters associated with current use may define aspects of the current use that influence the energy harvesting ability, such as of the WD. In one or more example methods, the parameters associated with the current use are indicative of the WD's ability to harvest energy during current use. In one or more example methods, the parameters associated with the current use are indicative of one or more of an energy consumption, environmental conditions (such as temperature, light, humidity, sunlight, etc,.), location (such as the geographical position of the WD and/or whether the WD is located indoor or outdoor), traffic behavior (such as when, what type of transmission and/or the load of the current traffic), a mobility pattern (such as a movement pattern of the WD or whether the WD is stationary or not), and current ability to harvest energy of the WD.

In one or more example methods, the network node may receive parameters associated with current use of the WD from an external device, such as a second network node and/or a second WD, such as a sensor measuring one or more environmental conditions of the WD, a weather station, a location server, a WD application usage profile, subscriber information etc. In one or more examples, it can be an ambient light sensor to sense the amount of ambient light present. The reported value can be using Lux unit as the standardized unit of light level intensity or power per cm² of a photovoltaic cell. Direct sunlight condition can be reported with more than 32000 Lux or 50 uW/cm² with 15% efficiency during the night it can be less than 1 lux or in range of nW per cm². The reported value can be based on the normalized value, such as “1” is the highest represent direct sunlight condition and “0” represents a full darkness. In one or more examples, location can be reported as geographical location, relative position to the previous report, or whether the wireless device is stationary or not. Other input examples can include weather information such as humidity, wind, barometric pressure, the height of the sun etc., and/or positioning information such as positioning in GPS coordinates and movement in km/h and compass direction in degrees. Furthermore, the network node is expected to utilize the reported information from the wireless device. For example, if the wireless node reports a stationary position, then the network node may apply the same algorithm and/or AI model.

In one or more example methods, the method 100 comprises predicting S107, using the algorithm, the energy level of the WD. In one or more example methods, the predicting is based on the assistance information received from the WD. In one or more example methods, the predicting is based on the received parameters required by the algorithm for predicting the energy level of the WD. The network node may predict the energy level based on the stored energy and the energy that can be harvested based on the energy harvesting properties, such as based on the available energy harvesting sources of the WD. In one or more example methods, the network node may use, such as predict the energy level based on, information received from other sources, such as environmental information from a weather station or data from an operator, etc.

In one or more example methods, the method 100 comprises determining S108, based on the predicted energy level of the WD, whether the energy level of the WD is sufficient for communicating with the WD. The energy level may be determined to be sufficient when the harvested and/or stored energy is estimated to be higher than the required energy for communication, such as the energy consumed during communication. Correspondingly, the energy level may be determined to be insufficient when the harvested and/or stored energy is lower than the required energy for communication, such as the energy consumed during communication.

In one or more example methods, the method 100 comprises, upon determining that the energy level of the WD is sufficient, scheduling S108A communication with the WD based on the predicted energy level, such as based on the predicted stored energy level and/or the predicted harvested energy level. The network node may thus schedule the communication with the WD such that an interruption of the communication due to insufficient power at the WD does not occur. This may also be referred to as resuming communication. Scheduling S108A communication corresponds to S205 of FIG. 4 and is similar to 1008 and/or 1016 of FIG. 7.

In one or more example methods, upon determining that the energy level of the WD is insufficient, the method comprises performing S108B refraining from scheduling communication with the WD for a time period while preserving a UE context for the WD. The time period may e.g., be a time period predicted to be required by the WD for harvesting sufficient energy to perform communications. In one or more example methods, such as when the method is performed by a RAN node, the RAN node may signal to the core network, such as to a core network node, that the core network is to refrain from scheduling communication with the WD and is to preserve the UE context of the WD. Therefore, when the method is performed by a RAN node, this implies that information is signaled between the CN node and the RAN node. Thereby, the network node can enable the WD to harvest energy to be able to receive the communication at a later stage. This can also prevent information from being lost due to the WD being unavailable due to insufficient power.

In one or more example methods, some of the actions of the method (such as the refraining from scheduling communication and/or preserving of the UE context) may be performed in the network node performing the prediction of the energy level of the WD or in another node. Hence, the network node may instruct, or inform, another network node to perform one or more of the actions performed in method 100. In one or more example methods, the network node may instruct, or inform, a second network node, such as a core network node, to refrain from scheduling communication with the WD and is to preserve the UE context of the WD.

In one or more example methods, upon determining that the energy level of the WD is insufficient, the method comprises performing S108B setting the WD in a power limited sub-state in which the WD is harvesting energy and is unavailable for communications, while the UE context for the WD is preserved. The power limited sub-state may be a substate of the RRC mode that the WD is currently in, as shown in FIG. 2. S108B is similar to 1010 of FIG. 7.

In one or more example methods, upon determining that the energy level of the WD is insufficient, the method comprises performing S108D assisting the WD to harvest energy from dedicated radio frequency by performing a wireless power transfer. In other words, the network node may perform a wireless power transfer to assist the WD in harvesting energy from dedicated radio frequencies. The network node may for example perform wireless power transfer to the WD during a predefined or an estimated time interval. The time interval may correspond to a period where the WD also would be expected to be able to do the RF energy harvesting, e.g., using a waveform and/or signal dedicated for energy harvesting. The network may assist to perform energy harvesting from other resources for instance by transmitting excitation signal to generate vibration or thermal energy on the corresponding energy generating device with in or in vicinity of WD. S108D is similar to 1012 of FIG. 7.

In one or more example methods, the method 100 comprises transmitting S108C, to the WD, a message configuring the WD to harvest energy. The message configuring the WD to harvest energy may for example indicate to the WD that it is to harvest energy (instead of performing communication or stay in connected mode). The message configuring the WD to harvest energy may in one or more example methods be sent during an optimal time to perform energy harvesting using the energy harvesting technique indicated in the energy harvesting properties received from the WD. The message configuring the WD to harvest energy may be transmitted via control signaling and/or may be a control message.

In one or more example methods, the method 100 comprises receiving S109, from the WD, updated parameters for use by the algorithm for predicting the energy level of the WD. The parameters may for example be updated when some of the conditions change, such as when new harvesting techniques are available for the WD and/or when the optimal time/conditions for harvesting energy is available. New harvesting techniques may for example be available when harvesting techniques become activated or available due to new usage of the WD, such as activating an energy harvesting source harvesting energy from vibrations when a previously stationary WD starts to move. The updated parameters for use by the algorithm for predicting the energy level of the WD may be received via control signaling and/or via a control message. In one or more examples, the parameters may be updated in case the position of the WD, which may be a sensor, is disrupted, such as when the WD is moved or rotated. In one or more examples, the parameters may be updated in case the WD is temporarily obstructed from energy harvesting by something. In one or more example methods, the WD may be deployed for a different use. For example, if the WD is a temperature sensor that has been used for measurement of temperature on the outside of a building in direct sunlight and the WD is moved to a basement for measuring the temperature in the basement where there is no direct sunlight, the WD may transmit updated parameters relating to the new environment that enables the WD to predict the energy level of the WD in the new environment using the algorithm and/or to update the algorithm itself, such as obtain an algorithm that is better suited for predicting the energy level in the new environment. For example, in one or more examples the WD is a sensor reporting the conditions of a bicycle, such as velocity, position, etc., and harvests energy from vibration generated by movement of the bicycle with a certain mobility pattern, such as travelling a certain route at a certain time of day. The WD may transmit an updated parameters related to the harvesting pattern when the sensor experiences a different mobility pattern. Receiving S109 updated parameters for use by the algorithm for predicting the energy level of the WD to S209 of FIG. 4 and is similar to 1004 of FIG. 7.

In one or more example methods, the method 100 comprises receiving S111, from the WD, training data for updating the algorithm for predicting the energy level of the WD. In one or more examples, such as when the algorithm is an AI and/or a machine learning model, the training data may be used to train the model. The training data is the data that is required for the selected algorithm and parameters that have been communicated earlier. The training data may in one or more example methods comprise real use data, such as energy consumption data, traffic data, and/or mobility pattern, measured by the WD. The training data may be received via control signaling and/or via a control message. By receiving training data, the network node is enabled to train the algorithm to provide a more accurate estimation of the energy level of the WD. Receiving S111 updated parameters for use by the algorithm for predicting the energy level of the WD to S211 of FIG. 4 and is similar to 1018 of FIG. 7.

In one or more example methods, the method 100 comprises updating S112 the algorithm, such as the AI and/or a machine learning model, for predicting the energy level of the WD based on the training data. Updating S112 the algorithm corresponds to 1020 of FIG. 7.

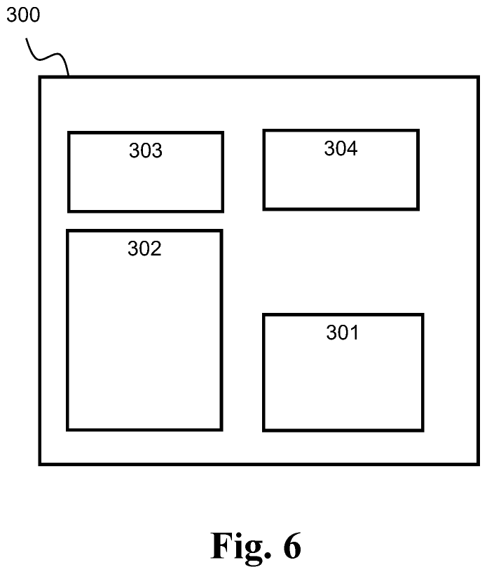

FIG. 4 shows a flow diagram of an example method 200, performed in an energy harvesting wireless device, WD, according to the disclosure, for enabling a prediction of an energy level of the energy harvesting WD by a network node, such as the network node of FIG. 3, and FIG. 5. The method 100 may be performed by an energy harvesting WD, such as the energy harvesting wireless device 300 of FIG. 1, and FIG. 6.

In one or more example methods, the method 200 comprises communicating S201 a message initiating using prediction of the energy level of the WD in the network node. This action S201 corresponds to the action S101 performed by the network node as discussed in relation to FIG. 3.

The method 200 comprises transmitting S203, to the network node, information assisting the network node to obtain, such as receive and/or retrieve, an algorithm for predicting the energy level of the WD. The information assisting the network node to obtain, such as receive and/or retrieve, the algorithm for predicting the energy level of the WD may be transmitted via control signaling and/or a control message comprising the information. This action S203 corresponds to the action S103 performed by the network node as discussed in relation to FIG. 3 and is similar to 1002 of FIG. 7.

The method 200 comprises transmitting S205, to the network node, parameters for use by the algorithm in predicting the energy level of the WD. The parameters for use by the algorithm in predicting the energy level of the WD may be transmitted via control signaling and/or a control message comprising the information. This action S205 corresponds to the action S105 performed by the network node as discussed in relation to FIG. 3 and is similar to 1002 of FIG. 7.

In one or more example methods, the parameters for use by the algorithm in predicting the energy level of the WD comprise harvesting properties and parameters associated with a current use of the WD, thereby enabling the network node to predict the energy level of the WD. The harvesting properties and the parameters associated with a current use of the WD correspond to the harvesting properties and the parameters associated with a current use of the WD for the network node described in relation to FIG. 3.

In one or more example methods, the method 200 comprises transmitting S209, to the network node, updated parameters required by the algorithm for predicting the energy. The updated parameters for use by the algorithm for predicting the energy level of the WD may be transmitted via control signaling and/or via a control message. This action S209 corresponds to the action S109 performed by the network node as discussed in relation to FIG. 3 and is similar to 1004 of FIG. 7.

In one or more example methods, the method 200 comprises transmitting S211, to the network node, training data for updating the algorithm for predicting the energy level of the WD. The training data may be transmitted via control signaling and/or via a control message. This action S211 corresponds to the action S111 performed by the network node as discussed in relation to FIG. 3 and is similar to 1018 of FIG. 7.

In one or more example methods, the method 200 comprises indicating S207, to the network node, that the WD is able to harvest energy. The indication may for example be sent when the WD has been unable to harvest energy and returns to being able to harvest energy, in order to update the harvesting conditions for the WD at the network node.

In one or more example methods, the method 200 comprises, upon the energy level of the WD being insufficient for communication with the network node, harvesting energy.

In one or more example methods, the method 200 comprises, upon the energy level of the WD being insufficient for communication with the network node, refraining from communicating with the network node.

In one or more example methods, the method 200 comprises, upon the energy level of the WD being insufficient for communication with the network node, entering the power limited sub-state. In the power limited sub-state the WD may only harvest energy and may refrain from communicating with the network node. In the power limited sub-state the UE context of the WD may be preserved by the network node.

In one or more example methods, the method 200 comprises, upon the energy level of the WD being insufficient for communication with the network node, configuring a harvesting device or receiver of the WD to harvest energy from dedicated radio frequency by wireless power transfer. The WD may receive a wireless power transfer from the network node during a predefined or an estimated time interval. For example, configuring the device to perform energy harvesting from other resources for instance by transmitting excitation signal to generate vibration or thermal energy on the corresponding generator device with in or in vicinity of WD. The excitation signal is transmitted for a certain time interval or includes information which indicates the potential energy generation or harvesting time interval.

In one or more example methods, the energy harvesting properties are indicative of one or more of energy harvesting techniques which the WD has currently selected, such as has selected to use, or is capable of using, for energy harvesting.

In one or more example methods, the energy harvesting techniques comprise one or more of ambient energy such as light energy, solar energy, vibration energy) and dedicated energy (such as wireless power transfer).

In one or more example methods, the parameters associated with the current use are indicative of one or more of an energy consumption, environmental conditions, location, traffic behavior, and current ability to harvest energy of the WD.

In one or more example methods, the parameters associated with the current use are indicative the WD's ability to harvest energy during current use.

FIG. 5 shows a block diagram of an example network node 800 according to the disclosure. The network node 800 comprises memory circuitry 401, processor circuitry 402, and an interface 403, such as a wired and/or wireless interface. The network node 800 may be configured to perform any of the methods disclosed in FIG. 3. In other words, the network node 800 may be configured for enabling a prediction of an energy level of an energy harvesting wireless device, WD, such as the wireless device 300 of FIG. 1, and FIG. 6. The network node 800 may be a RAN node 400 or a CN node 600 of FIG. 1. When the network node 800 is a CN node 600, the CN node 600 may be configured to communicate with the WD 300 via a RAN node 400. The network node 800 is configured to receive (such as via the wireless interface 403), from the WD, information assisting the network node to obtain an algorithm for predicting the energy level of the WD.

The network node 800 is configured to receive (such as via the wireless interface 403), from the WD, parameters for use by the algorithm in predicting the energy level of the WD.

In one more example network nodes, the parameters comprise energy harvesting properties and parameters associated with current use of the WD, whereby prediction of the energy level of the WD is enabled.

The interface 403 may be configured for wireless communications via a wireless communication system, such as a 3GPP system, such as a 3GPP system supporting one or more of: New Radio, NR, Narrow-band IoT, NB-IoT, Long Term Evolution, LTE, and Long Term Evolution—enhanced Machine Type Communication, LTE-M, supporting various frequency range, such as millimeter-wave communications, operating in licensed band and/or unlicensed band.

The interface 403 may be configured for communication with a network node, such as a radio network node or a core network node.

Processor circuitry 402 is optionally configured to perform any of the operations disclosed in FIG. 3 (such as any one or more of S101, S107, S108, S108A, S108C, S109, S111, S112). The operations of the network node 400 may be embodied in the form of executable logic routines (for example, lines of code, software programs, software models, etc.) that are stored on a non-transitory computer readable medium (for example, memory circuitry 401) and are executed by processor circuitry 402).

Furthermore, the operations of the network node 400 may be considered a method that the network node 400 is configured to carry out. Also, while the described functions and operations may be implemented in software, such functionality may also be carried out via dedicated hardware or firmware, or some combination of hardware, firmware and/or software.

Memory circuitry 401 may be one or more of a buffer, a flash memory, a hard drive, a removable media, a volatile memory, a non-volatile memory, a random access memory (RAM), or other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 5). Memory circuitry 401 is considered a non-transitory computer readable medium.

Memory circuitry 401 may be configured to store parameters associated with the current method (such as algorithms, AI models, machine learning models, parameters for use by the algorithm in predicting the energy level of the WD, energy harvesting properties and/or parameters associated with current use of the WD) in a part of the memory.

FIG. 6 shows a block diagram of an example energy harvesting wireless device 300 according to the disclosure. The energy harvesting wireless device 300 comprises memory circuitry 301, processor circuitry 302, a wireless interface 303, and energy harvesting circuitry 304. The energy harvesting wireless device 300 may be configured to perform any of the methods disclosed in FIG. 4. In other words, the energy harvesting wireless device 300 may be configured for enabling a prediction of an energy level of the energy harvesting wireless device, WD, by a network node such as network node of FIG. 3 and FIG. 5.

The energy harvesting wireless device 300 is configured to transmit (such as via the wireless interface 303), to the network node, information assisting the network node to obtain an algorithm for predicting the energy level of the WD.

The energy harvesting wireless device 300 is configured to transmit (such as via the wireless interface 303), to the network node, parameters for use by the algorithm in predicting the energy level of the WD.

In one or more example energy harvesting wireless devices, the parameters comprise harvesting properties and parameters associated with a current use of the WD, thereby enabling the network node to predict the energy level of the WD.

The wireless interface 303 is configured for wireless communications via a wireless communication system, such as a 3GPP system, such as a 3GPP system supporting one or more of: New Radio, NR, Narrow-band IoT, NB-IoT, and Long Term Evolution—enhanced Machine Type Communication, LTE-M, millimeter-wave communications, such as millimeter-wave communications in licensed bands, such as device-to-device millimeter-wave communications in licensed bands.

The energy harvesting circuit 304 may be configured to harvest energy from an energy source. The energy source may be an ambient energy (such as light energy, wind energy and/or vibration energy), or a dedicated energy source (such as wireless power transfer). Ambient energy harvesting relies on energy resources that are readily available in the environment and that can be sensed by energy harvesting devices where dedicated energy harvesting are characterized by on-purpose energy transmissions from dedicated energy sources to energy devices.

The energy harvesting device 300 may, in one or more example methods, comprise one or more sensors. The one or more sensors may for example be configured to monitor the surroundings of the WD 300. The energy harvesting wireless device 300 is optionally configured to perform any of the operations disclosed in FIG. 4 (such as any one or more of S201, S207, S209, S211). The operations of the energy harvesting wireless device 300 may be embodied in the form of executable logic routines (for example, lines of code, software programs, etc.) that are stored on a non-transitory computer readable medium (for example, memory circuitry 301) and are executed by processor circuitry 302).

Furthermore, the operations of the energy harvesting wireless device 300 may be considered a method that the energy harvesting wireless device 300 is configured to carry out. Also, while the described functions and operations may be implemented in software, such functionality may also be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 6). Memory circuitry 301 is considered a non-transitory computer readable medium.

Memory circuitry 301 may be configured to store parameters associated with the current method (such as algorithms, AI models, machine learning models, parameters for use by the algorithm in predicting the energy level of the WD, energy harvesting properties and/or parameters associated with current use of the WD) in a part of the memory.

FIG. 7 is a signaling diagram disclosing an exemplary message exchange between an exemplary network node 800 and an exemplary WD 300 according to the current disclosure. In this example the algorithm for predicting the energy level is an AI model. The network node 800 may be a RAN node 400 or a CN node 600 of FIG. 1. When the network node 800 is a CN node 600, the CN node 600 may be configured to communicate with the WD 300 via a RAN node 400.

In an initialization phase, the WD and the network node exchange messages 1002 initializing the predicting of the energy level by the network node. Here the basic AI model may be defined, based on capabilities, such as UE capabilities, of the WD. Alternatively, this information may be pre-defined and/or based on WD subscription. In this phase the AI model is initialized. This may occur once in a lifetime of the WD and may subsequently be updated repeatedly. This is similar to S101, S103, S201 and S203 described in relation to FIG. 3 and FIG. 4.

The WD transmits parameters 1004 for use by the algorithm for predicting an energy level of the WD, such as available harvesting techniques for the WD to the network node, such as solar, vibration, RF energy etc. and assistance information, e.g., location, sensing (environmental data, sensor inputs), mobility pattern etc., to the wireless device. This corresponds to step S105, S109, S205 and S209 described in relation to FIG. 3 and FIG. 4.

The network node may further receive parameters 1022 for use by the algorithm for predicting an energy level of the WD from one or more external devices.

The WD may be in RRC connected mode 1005 with communication scheduled. When the WD is in RRC connected mode, the WD may initiate communication, for example by transmitting a scheduling request 1007 to the WD.

The network node predicts 1006 the energy level of the WD using the AI model and the received parameters from the WD and/or the external device. This prediction may consider the input from the WD, as well as additional input from other sources, like whether station, location server, WD application usage profile, subscriber information etc. This additional input may in one or more example methods have been provided to the network node prior to the signaling from the WD. Based on this information the network node predicts the energy level of the WD, such as based on the energy harvesting resources available to the WD. This corresponds to S107 of FIG. 3.

When an energy harvesting source or stored energy is available and/or the energy level is sufficient, the network node schedules 1008 communication with the WD based on the predicted energy harvesting, for example using a Layer 1 (L1) protocol or a Layer 2 (L2) protocol. This corresponds to S108A of FIG. 3.

If the energy level is insufficient, the network node may predict an energy harvesting technique used by the WD. The network node predicts a time for harvesting energy based on the predicted technique. The network node starts a timer related to the predicted time. The network node may further pause communication with the WD. This is similar to S108B of FIG. 3.

When the energy level is insufficient, the WD may enter 1010 the power limited sub-state. In the power limited sub-state the WD may only harvest energy and may refrain from communicating with the network node. In the power limited sub-state the UE context of the WD may be preserved by the network node.

When the predicted harvesting technique of the WD is wireless power transfer the network node may perform wireless power transfer 1012 to the WD, such as in a predefined or estimates time interval, corresponding to a period where the WD also would be expected to be able to do the RF energy harvesting.

When the timer has elapsed, or when the harvesting has been done by the WD and the energy level is sufficient, the WD may resume communication by sending a scheduling request 1014 to the network node and/or the network node may resume scheduling 1016. The scheduling may consider potential status of harvesting and energy level of the WD.

The WD may provide updated parameters 1018 on energy level and harvesting, such as real data on energy level and harvesting achievement measured by the WD, and/or updated parameters for use by the algorithm. This corresponds to S111 of FIGS. 3 and S211 of FIG. 4.

Based on the received feedback and updated parameters, the network node trains 1020 the AI model, e.g., using machine learning, to enhance the AI model.

Steps 1004-1022 may be repeated 1024 every time the WD sends updated assistance information to the network node.

Examples of methods and products (network node and wireless device) according to the disclosure are set out in the following items:
Item 1. A method, performed in a network node, enabling a prediction of an energy level of an energy harvesting wireless device, WD, the method comprising:
   receiving (S103), from the WD, information assisting the network node to obtain an algorithm for predicting the energy level of the WD,
   receiving (S105), from the WD, parameters for use by the algorithm in predicting the energy level of the WD, wherein the parameters comprise energy harvesting properties and parameters associated with current use of the WD, whereby prediction of the energy level of the WD is enabled.
Item 2. The method according to item 1, wherein the method comprises:
   communicating (S101) a message initiating using prediction of the energy level of the WD in the network node.
Item 3. The method according to item 1 or 2, wherein the method comprises:
   predicting (S107), using the algorithm, the energy level of the WD, wherein the predicting is based on the received parameters required by the algorithm for predicting the energy level of the WD.
Item 4. The method according to item 3, wherein the method comprises:
   determining (S108), based on the predicted energy level of the WD, whether the energy level of the WD is sufficient for communicating with the WD.
Item 5. The method according to item 4, wherein the method comprises:
   upon determining that the energy level of the WD is sufficient, scheduling (S108A) communication with the WD based on the predicted energy level.
Item 6. The method according to item 4, wherein the method comprises, upon determining that the energy level of the WD is insufficient, performing (S108B) at least one of:
   refraining from scheduling communication with the WD for a time period while preserving a UE context for the WD,
   setting the WD in a power limited sub-state in which the WD is harvesting energy and unavailable for communications while the UE context for the WD is preserved, and
   assisting the WD to harvest energy from dedicated radio frequency by performing a wireless power transfer.
Item 7. The method according to item 5 or 6, wherein the method comprises:
   transmitting (S108C), to the WD, a message configuring the WD to harvest energy.
Item 8. The method according to any one of the previous items, wherein the method comprises:
   receiving (S109), from the WD, updated parameters required by the algorithm for predicting the energy level of the WD.
Item 9. The method according to any one of the previous items, wherein the method comprises:
   receiving (S111), from the WD, training data for updating the algorithm for predicting the energy level of the WD.
Item 10. The method according to item 9, wherein the method comprises:
   updating (S112) the algorithm for predicting the energy level of the WD based on the training data.
Item 11. The method according to any of the previous items, wherein the energy harvesting properties are indicative of one or more of energy harvesting techniques which the WD has currently selected for energy harvesting.
Item 12. The method according to item 11, wherein the energy harvesting techniques comprise one or more of ambient or dedicated energy such as solar energy, vibration energy, and/or wireless power transfer.
Item 13. The method according to any of the previous items, wherein the parameters associated with the current use are indicative of one or more of an energy consumption, environmental conditions, location, traffic behavior, and current ability to harvest energy of the WD.
Item 14. The method according to any one of the previous claims, wherein the parameters associated with the current use are indicative the WD's ability to harvest energy during current use.
Item 15. A method, performed in an energy harvesting wireless device, WD, enabling a prediction of an energy level of the energy harvesting wireless device, WD, by a network node, the method comprising:
   transmitting (S203), to the network node, information assisting the network node to obtain an algorithm for predicting the energy level of the WD,
   transmitting (S205), to the network node, parameters for use by the algorithm in predicting the energy level of the WD, wherein the parameters comprise harvesting properties and parameters associated with a current use of the WD, thereby enabling the network node to predict the energy level of the WD.
Item 16. The method according to item 15, wherein the method comprises:
   communicating (S201) a message initiating using prediction of the energy level of the WD in the network node.
Item 17. The method according to any of items 15-16, wherein the method comprises:
   transmitting (S209), to the network node, updated parameters required by the algorithm for predicting the energy level of the WD.
Item 18. The method according to any of items 15-17, wherein the method comprises:
   transmitting (S211), to the network node, training data for updating the algorithm for predicting the energy level of the WD.
Item 19. The method according to any of items 15-18, wherein the method comprises:
   indicating (S207), to the network node, that the WD is able to harvest energy.
Item 20. The method according to any one of items 15-19, wherein the method comprises, upon the energy level of the WD being insufficient for communication with the network node, performing at least one of:
   harvesting energy,
   refraining from communicating with the network node,
   entering a power limited sub-state, and
   configuring a harvesting device or receiver of the WD to harvest energy from dedicated radio frequency by wireless power transfer.
Item 21. The method according to any one of the Items 15-20, wherein the energy harvesting properties are indicative of one or more of energy harvesting techniques which the WD has currently selected for energy harvesting.
Item 22. The method according to item 21, wherein the energy harvesting techniques comprise one or more of ambient or dedicated energy such as solar energy, vibration energy, and/or wireless power transfer.
Item 23. The method according to any of the items 15-22, wherein the parameters associated with the current use are indicative of one or more of an energy consumption, environmental conditions, location, traffic behavior, and current ability to harvest energy of the WD.
Item 24. The method according to any of the items 15-23, wherein the parameters associated with the current use are indicative the WD's ability to harvest energy during current use.
Item 25. A network node comprising memory circuitry, processor circuitry, and a wireless interface, wherein the network node is configured to perform any of the methods according to any of items 1-14.
Item 26. A wireless device comprising memory circuitry, processor circuitry, and a wireless interface, wherein the wireless device is configured to perform any of the methods according to any of items 15-24.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1 to 7 comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed in a network node of a communication network, enabling a prediction of an energy level of an energy harvesting wireless device (WD) the method comprising:
receiving, from the WD, control signaling comprising information assisting the network node to obtain an algorithm for predicting the energy level of the WD,
receiving, from the WD, control signaling comprising parameters for use by the algorithm in predicting the energy level of the WD, wherein the parameters comprise energy harvesting properties and parameters associated with current use of the WD, whereby prediction of the energy level of the WD is enabled.

2. The method according to claim 1, wherein the method comprises:
communicating a message initiating using prediction of the energy level of the WD in the network node.

3. The method according to claim 1, or 2, wherein the method comprises:
predicting, using the algorithm, the energy level of the WD, wherein the predicting is based on the received parameters required by the algorithm for predicting the energy level of the WD.

4. The method according to claim 3, wherein the method comprises:
determining, based on the predicted energy level of the WD, whether the energy level of the WD is sufficient for communicating with the WD.

5. The method according to claim 4, wherein the method comprises:
upon determining that the energy level of the WD is sufficient, scheduling communication with the WD based on the predicted energy level.

6. The method according to claim 4, wherein the method comprises upon determining that the energy level of the WD is insufficient, performing at least one of:
refraining from scheduling communication with the WD for a time period while preserving a UE context for the WD,
setting the WD in a power limited sub-state in which the WD is harvesting energy and unavailable for communications while the UE context for the WD is preserved, and
assisting the WD to harvest energy from dedicated radio frequency by performing a wireless power transfer.

7. The method according to claim 5, wherein the method comprises:
transmitting, to the WD, a message configuring the WD to harvest energy.

8. The method according to claim 1, wherein the method comprises:
receiving, from the WD, control signaling comprising updated parameters required by the algorithm for predicting the energy level of the WD.

9. The method according to claim 1, wherein the method comprises:
receiving, from the WD, control signaling comprising training data for updating the algorithm for predicting the energy level of the WD.

10. The method according to claim 9, wherein the method comprises:
updating the algorithm for predicting the energy level of the WD based on the training data.

11. The method according to claim 1, wherein the energy harvesting properties are indicative of one or more of energy harvesting techniques which the WD has currently selected for energy harvesting.

12. The method according to claim 11, wherein the energy harvesting techniques comprise one or more of ambient or dedicated energy such as solar energy, vibration energy, and/or wireless power transfer.

13. The method according to claim 1, wherein the parameters associated with the current use are indicative of one or more of an energy consumption, environmental conditions, location, traffic behavior, and current ability to harvest energy of the WD.

14. The method according to claim 1, wherein the parameters associated with the current use are indicative the WD's ability to harvest energy during current use.

15. A method, performed in an energy harvesting wireless device (WD) of a communication network, enabling a prediction of an energy level of the energy harvesting wireless device (WD) by a network node, the method comprising:
transmitting, to the network node, control signaling comprising information assisting the network node to obtain an algorithm for predicting the energy level of the WD,
transmitting, to the network node, control signaling comprising parameters for use by the algorithm in predicting the energy level of the WD, wherein the parameters comprise harvesting properties and parameters associated with a current use of the WD, thereby enabling the network node to predict the energy level of the WD.

16. The method according to claim 15, wherein the method comprises:
communicating a message initiating using prediction of the energy level of the WD in the network node.

17. The method according to claim 15, wherein the method comprises:
transmitting, to the network node, control signaling comprising updated parameters required by the algorithm for predicting the energy level of the WD.

18. The method according to claim 15, wherein the method comprises:
transmitting, to the network node, control signaling comprising training data for updating the algorithm for predicting the energy level of the WD.

19. The method according to claim 15, wherein the method comprises:
indicating, to the network node, that the WD is able to harvest energy.

20. The method according to claim 15, wherein the method comprises, upon the energy level of the WD being insufficient for communication with the network node, performing at least one of:
harvesting energy,
refraining from communicating with the network node,
entering a power limited sub-state, and
configuring a harvesting device or receiver of the WD to harvest energy from dedicated radio frequency by wireless power transfer.

21-26. (canceled)
